(19) United States
(12) Patent Application Publication
(10) Pub. No.: US 2007/0008886 A1
(43) Pub. Date: Jan. 11, 2007

(54) TRANSMISSION APPARATUS FOR REDUCING DELAY VARIANCE AND RELATED METHOD

(76) Inventors: Yih-Shen Chen, Hsin-Chu Hsien (TW); Chung-Ju Chang, Hsin-Chu Hsien (TW); Zhi-Ming Yen, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 11/160,522

(22) Filed: Jun. 28, 2005

(51) Int. Cl. H04L 12/26

(52) U.S. Cl. 370/230

(57) ABSTRACT

A transmission apparatus and related method for reducing the delay variance of a plurality of data transmitted from a sender to a receiver in a communication system are disclosed. The method includes: assigning a permission probability to the sender; and before a data is to be sent to the receiver from the sender, and determining if the sender is allowed to transmit the data according to the permission probability.

### BACKGROUND OF THE INVENTION

1. Field of the Invention

The invention relates to a transmission apparatus and related method applied in a communication system, and more particularly, to a transmission apparatus and related method for reducing delay variance.

2. Description of the Prior Art

Multiple access technology is popular is digital communication systems. For example, the Carrier Sense Multiple Access with Collision Avoidance (CSMA/CA) protocol is generally utilized to transmitting digital data in a communication channel, and provides a plurality of senders in the communication channel an equal opportunity to send data. To prevent the data sent by different senders from causing collisions, the CSMA/CA protocol adopts a Binary Exponential Backoff (BEB) algorithm. The key feature of the BEB algorithm is to delay the retransmission of a collided packet by a random time. As the number of collisions increase, the range of the random time increases. For example, after a sender S1 sends a packet P1 in the communication channel, the sender S1 listens to the communication channel to determine if the sent packet collided with a packet sent by another sender. If a collision is detected by the sender S1, the sender S1 will randomly selected a time from the set {0 us, 51.2 us} to retransmit the packet P1. If 0 us is selected, the sender S1 retransmits the packet P1 immediately. If the 51.2 us is selected, the sender S1 will retransmit the packet P1 51.2 us later. If the packet P1 collided a second time with a packet sent by another sender then the sender S1 will randomly select a time from the set {0 us, 51.2 us, 102.4 us, and 153.6 us} to retransmit the packet P1. The number of the elements of the set increases exponentially. In the same manner, if the packet P1 is collided for three times, the sender S1 randomly selects a time from the set {0 us, 51.2 us, 102.4 us, 153.6 us, 204.8 us, 256 us, 307.2 us, and 358.4 us} to retransmit the packet P1. After the packet P1 is retransmitted more than ten times, the range of randomly selected time values (i.e., the set of time) remains. The number of collisions will increase as more senders utilize the communication channel to transmit data. Because of the collision, some data are delay. However, some other data are quickly received by the receiver if no collision occurs. As a result, the delay variance of those data increases.

Since the digital communication systems for executing real time applications have gained more popularity in past recent years. People can download static information from the Ethernet and enjoy movies or songs on-line. For example, when an end user utilizes a terminal equipment, such as a personal computer, to receive and then play in real time a movie, the terminal equipment must establish a connection with a server providing the real time service. Next, the server will transmits a series of data D1, D2 . . . Dn to the personal computer. The personal computer reconstructs the received data D1, D2 . . . Dn to form a frame F1, and then displays the frame F1 on the monitor of the personal computer. In the same manner, before the monitor shows the next frame F2, the personal computer must successfully receive the data Dn+1, Dn+2, . . . D2n from the server, and reconstruct the data Dn+1, Dn+2, . . . D2n to form the frame F2. In an ideal situation, the sequentially transmitted data from the server are received by the personal computer one by one. In other words, the delay times of every data from the server to the personal computer are identically equal. However, since the condition of the communication channel is very dynamic and changes with time, the delay times of every data are different. For example, when transmitting the data D1 and D2, if the communication channel is clear, the data D1, D2 is received by the personal computer without retransmitting. When transmitting the data D3, D4, if the communication channel is noisy (i.e., too many senders in the communication channel), the data D3, D4 may be retransmitted several times because of collisions. As a result, the delay times of the data D3, D4 is longer than the delay times of the data D1, D2. Please note, as the delay variance of data increases the user will feel more uncomfortable as the frames will be displayed with unequal speed. To help alleviate this problem, the personal computer requires a larger buffer to store more data. The larger buffer is necessary because the digital communication system adopting the CSMA/CA protocol and BEB algorithm has no mechanism and does not attempt to solve the problem mentioned above. As a result, the amount of computation, the required system resources, and the power consumed by the terminal equipment all increase accordingly.

Besides, the traditional BEB algorithm is unfair. For example, the BEB algorithm may be favorable to the station just join the LAN. Consequently, many methods, such as the decentralized delay fluctuation control (DDFC) mechanism, are disclosed to solve this problem. However, these methods also have some drawbacks. Take the DDFC mechanism as an example, the DDFC mechanism may increase the collision probability and reduces the effective throughput consequently. As a result, a fair method capable of reducing the delay variance is necessary.

### SUMMARY OF THE INVENTION

It is therefore an objective of the claimed invention to provide a transmission apparatus applied in a digital communication system for reducing delay variance and related method to solve the problem mentioned above.

According to the claimed invention, a method for reducing the delay variance of a plurality of data is disclosed, where the plurality of data is transmitted from a sender to a receiver in a communication system. The method comprises: assigning a permission probability to the sender; and before a data is to be sent to the receiver from the sender, determining if the sender is allowed to transmit the data according to the permission probability.

According to the claimed invention, a transmission apparatus for reducing the delay variance of a plurality of data is disclosed, where the plurality of data is transmitted in a communication system. The transmission apparatus comprises: a permission probability generating module for generating a permission probability; and a transmission module, electrically connected to the permission probability generating module, for transmitting a data according to the permission probability; wherein before a data is to be sent by the transmission module, the transmission module determines if it is allowed to transmit the data according to the permission probability.

The present invention provides a permission probability generating module to generate a permission probability. The transmission module transmits the data, or does not transmit the data, according to the permission probability. As data is retransmitted more times it will have a higher permission probability. Given the higher permission probability, the probability of a successful transmission of the data increases. As a result, the delay time of each data is balanced and further the delay variance is reduced accordingly.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flow chart of the method for reducing the delay variance according to a preferred embodiment of the present invention.

FIG. 2 is a schematic diagram of the transmission apparatus according to a preferred embodiment of the present invention.

### DETAILED DESCRIPTION

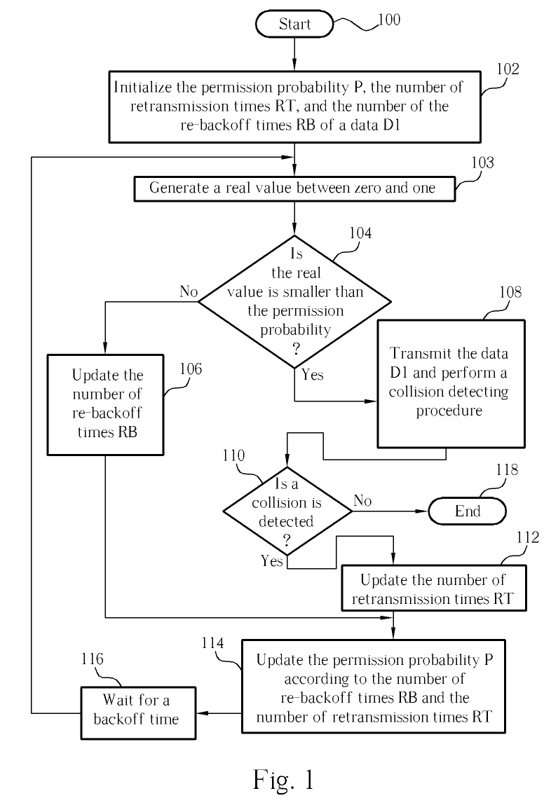

Please refer to FIG. 1. FIG. 1 is a flow chart of the method for reducing the delay variance according to a preferred embodiment of the present invention. In the preferred embodiment, the sender utilizing the method transmits data to a receiver according to the Carrier Sense Multiple Access with Collision Avoidance (CSMA/CA) protocol. The sender and the receiver are in a digital communication systems, such as a WLAN system or LAN system. The method comprises the following steps:

Step 100: Start.

Step 102: Assign the permission probability P of a data D1 to an initial value P0, and assign the number of retransmission times RT of the data D1, the number of the re-backoff times RB of the data D1, and a backoff time of the data D1 to zero.

Step 103: Generate a real value between zero and one.

Step 104: If the real value is smaller than the permission probability then proceed to step 108; otherwise, proceed to step 106.

Step 106: Update the number of re-backoff times RB by adding the number of re-backoff times RB to one, and proceed to step 114.

Step 108: Transmit the data D1 and then perform a collision detecting procedure to detect if a collision happens to the data D1.

Step 110: If the collision is detected, proceed to step 112; otherwise, proceed to step 118.

Step 112: Update the number of retransmission times RT by adding the number of retransmission times RT to one, and update the backoff time according to the BEB algorism.

Step 114: Update the permission probability P according to the number of re-backoff times RB and the number of retransmission times RT.

Step 116: Wait for the backoff time, and proceed to step 103.

Step 118: End.

Firstly, as the sender prepares to transmit a data D1, the sender initializes the permission probability P, the number of retransmission times RT, and the number of the re-backoff time RB of the data D1 (Step 102). According to the present embodiment, the initial value P0 of the permission probability P is 0.5, and the initial values of the number of retransmission times RT and the number of the re-backoff time RB are both zero. Please note that the initial values mentioned above are not limited by the present embodiment. Next, the sender determines if it is allowed to transmit the data D1 according to the permission probability P (Steps 103, 104). In the preferred embodiment, the sender generates a real value between zero and one. If the real value is smaller than the permission probability, the sender is allowed to transmit the data D1; otherwise, the sender is not allowed to transmit the data D1.

If the sender is not allowed to transmit the data D1, the sender will update the number of re-backoff times RB by adding the number of re-backoff times RB to one (step 106) according to the present embodiment, and the backoff time of the data D1 remains. If the sender is allowed to transmit the data D1, the sender will send the data D1 and perform a collision detecting procedure (108). If no collision is detected, the data D1 is transmitted to the receiver successfully. That is the sender will prepare to send the next data D2, and performs the method again. If a collision is detected, the sender will update the number of retransmission times RT by adding the number of retransmission times RT to one, and update the backoff time according to the BEB algorism (step 112). Next, the sender calculates a new permission probability P according to the number of re-backoff times RB and the number of retransmission times RT. According to the preferred embedment, the operation of calculating the permission probability P is represented by the following equation:

$$P = P 0 + \frac{1 - P 0}{{BS}_{MAX}} \cdot ( RT + \frac{RB}{{RB}_{MAX} + 1} ) \qquad Equation ( 1 )$$

BS_{MAX} denotes the maximum backoff stage of the BEB algorithm. In the CSMA/CA protocol, the maximum backoff stage is ten. RB_{MAX} denotes the maximum of the number of the re-backoff times. According to the Equation (1), the permission probability P increases as the number of re-backoff times RB or the number of retransmission times RT increase. As the calculated permission probability P is greater than one, the permission probability P is determined to be one. In Equation (1), as the number of the retransmission of a specific data increases, the permission probability P of the specific data is higher. In other words, when the specific data is transmitted at a first time, the permission probability P of a specific data is the lowest. As a result, the delay times of a plurality of data are balanced through utilizing the permission probability and the delay variance is reduced at the same time. After the permission probability is calculated, the sender waits for the backoff time then determines if it is allowed to transmit the data D1 according to the updated permission probability P. Please note that the operation of determining the backoff time is well known by those skilled in the art therefore the related description is omitted for the sake of brevity. It should be noted that the method of generating the permission probability P is not limited to the Equation (1). Other methods for adjusting the permission probability P according to the number of re-backoff times RB or the number of retransmission times RT are covered by the claimed invention.

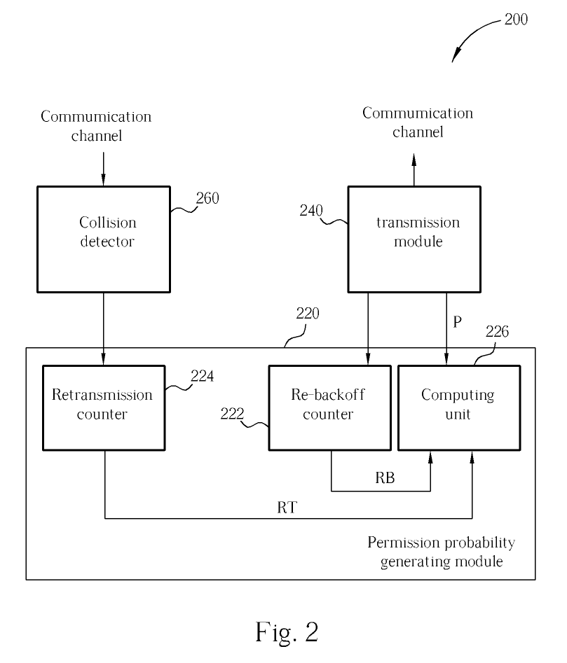

Please refer to FIG. 2. FIG. 2 is a schematic diagram of the transmission apparatus 200 capable of reducing the delay variance according to a preferred embodiment of the present invention. According to the preferred embodiment, the transmission apparatus 200 transmits data according to the Carrier Sense Multiple Access with Collision Avoidance (CSMA/CA) protocol, and is applied in a digital communication system, such as WLAN or LAN system. The transmission apparatus 200 comprises a permission probability generating module 220, a transmission module 240, and a collision detector 260. In the beginning, the permission probability generating module 220 generates a permission probability P to the transmission module 240. Next, the transmission module 240 determines that if it is allowed to transmit a data D1 according to the permission probability P. If it is not allowed to transmit the data D1, the permission probability generating module 220 will adjust the permission probability P higher. If the data D1 is transmitted by the transmission module 240, the collision detector 260 will perform a collision detecting procedure to detect if a collision happens to the data D1. Next, if a collision is detected, the permission probability generating module 220 will adjust the permission probability P higher. If no collision is detected (i.e., the data D1 is transmitted successfully), the permission probability generating module 220 will reset the permission probability P to an initial value P0 applied to transmission of a next data D2.

According to the preferred embodiment, the permission probability generating module 220 further comprises a re-backoff counter 222, a retransmission counter 224, and a computing unit 226. The re-backoff 222 is utilized to count the number of the re-backoff times RB of a specific data when the specific data is not allowed to be transmitted according to the permission probability. The retransmission counter 224 is utilized to count the number of the retransmission times RT of the specific data when a collision is detected. The computing unit 226 calculates the permission probability P of the specific data according to the number of the retransmission times RT and the number of the re-backoff times RB. Please note that operation of the computing unit 226 are detailed in the Equation (1) according to the preferred embodiment. So the detailed description of the operation of the computing unit 226 is omitted.

It should be noted that the method and apparatus capable of reducing the delay variance are not limited to combining with the CSMA/CA protocol. According to the claimed invention, the method and apparatus capable of reducing the delay variance may be combined with another kinds of multiple access protocols.

Compared with the prior art, the permission probability generating module generates a permission probability to determine if a data is allowed to be transmitted according to the present invention. Since the data, which is retransmitted more times or suffered collision more times, has higher permission probability, the probability of the data's successful transmission increases. Hence, the delay times of a plurality of data are balanced resulting in the delay variance being reduced accordingly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for reducing the delay variance of a plurality of data transmitted from a sender to a receiver in a digital communication system, the method comprising:
assigning a permission probability to the sender; and
before a data is to be sent to the receiver from the sender, determining if the sender is allowed to transmit the data according to the permission probability.

2. The method of claim 1, further comprising:
if the sender is not allowed to transmit the data according to the permission probability, increasing the permission probability assigned to the sender and then driving the sender to re-transmit the data.

3. The method of claim 1, further comprising:
if the data is transmitted to the receiver by the sender according to the permission probability, performing a collision detecting procedure to detect if a collision happens to the data; and
if the collision is detected by the collision detecting procedure, increasing the permission probability assigned to the sender and then driving the sender to re-transmit the data.

4. The method of claim 3, further comprising:
if the collision is not detected by the collision detecting procedure, resetting the permission probability to an initial value applied to transmission of a next data.

5. The method of claim 1, wherein the data is transmitted according to a Carrier Sense Multiple Access with Collision Avoidance (CSMA/CA) protocol.

6. The method of claim 1, wherein the digital communication system is a WLAN.

7. A transmission apparatus for reducing the delay variance of a plurality of data transmitted to a receiver in a digital communication system, the transmission apparatus comprising:
a permission probability generating module for generating a permission probability; and
a transmission module, electrically connected to the permission probability generating module, for transmitting a data according to the permission probability;
wherein before a data is sent by the transmission module, the transmission module determines if it is allowed to transmit the data according to the permission probability.

8. The transmission apparatus of claim 7, wherein if the transmission module is not allowed to transmit the data according to the permission probability, the permission probability generating module increases the permission probability and then driving the transmission module to re-transmit the data.

9. The transmission apparatus of claim 7, wherein the transmission apparatus further comprises:
a collision detector, for performing a collision detecting procedure to detect if a collision happens to the data when the data is transmitted according to the permission probability;
wherein if the collision is detected by the collision detector, the permission probability generating module increases the permission probability and then driving the sender to re-transmit the data.

10. The transmission apparatus of claim 9, wherein if no collision is detected by the collision detector, the permission probability generating module resets the permission probability to an initial value applied to transmission of a next data.

11. The transmission apparatus of claim 7, wherein the data is transmitted according to a carrier sense multiple access with collision avoidance (CSMA/CA) protocol.

12. The transmission apparatus of claim 7, wherein the digital communication system is a WLAN.
